(19) United States
(12) Patent Application Publication
(10) Pub. No.: US 2011/0302055 A1
(43) Pub. Date: Dec. 8, 2011

(54) SYSTEM AND METHOD FOR AN INTERNET BASED CHARITABLE EVENT

(76) Inventor: David G. Drake, Indialantic, FL (US)

(21) Appl. No.: 13/153,186

(22) Filed: Jun. 3, 2011

Related U.S. Application Data
(60) Provisional application No. 61/351,050, filed on Jun. 3, 2010.

(51) Int. Cl. G06Q 50/00; G06Q 30/00

(52) U.S. Cl. 705/26.61; 705/27.1; 705/26.8

(57) ABSTRACT

A system for an Internet based charitable event having a processor with software executing thereon. The software is in communication with a website, the website receives tax information about a charitable entity. A user selects one or more locations where to register, and enters information about a charitable event. The software creates a registration packet for each location, and sends each packet to a review authority for the corresponding location. The software tracks the approval status of each packet and sets the website to the approval status of each location. The website displays information about the entity and the event to a visitor who selects a billing location. If the appropriate review authority has approved the billing location, the visitor can purchase an online raffle ticket. The software creates a unique raffle ticket for each entry, randomly chooses a winning ticket, and notifies the winner.

### CROSS-REFERENCE TO RELATED APPLICATIONS

This patent application claims the benefit of, under Title 35, United States Code, Section 119(e), U.S. Provisional Patent Application No. 61/351,050, filed Jun. 3, 2010, which is incorporated herein by reference.

### FIELD OF THE INVENTION

The present invention is directed to a system that allows charitable entities a streamlined location and process to execute, run and manage a charitable event. The present invention is further directed to the corresponding method of executing, running and managing the charitable event. The present invention uses a website or series of websites in order to make the event visible and more accessible to a larger audience than a traditional local charitable event.

### BACKGROUND OF THE INVENTION

Some charitable entities run fundraising events or campaigns on local levels. For example, a 50/50 raffle may be run within the state where the charitable entity is registered. The publicity of this event may be limited to one state, thereby limiting the appeal and visibility of the event. This in turn limits the potential for funds raised towards the charity's cause. It is desirable for the charities to be able to run an event with broader appeal, but the book keeping and record keeping required to legally run an event across state lines prevents a charity from leveraging the visibility of the Internet to provide broader appeal for the charities' cause. In order to solicit funds across state lines, the charity must be able to provide an accounting of funds raised and prizes distributed. Further, if the event is not registered in a particular state, the charity may not solicit or accept funds originating from the unregistered state.

United States Patent Application Publication US 2007/0105612 to Fotevski discloses a computer network system that allows a user to register for games of chances throughout the country. The disclosed system has the ability to limit participation by geographical location by comparison between the areas where games of chances are permitted, excluded or restricted. The Fotevski application does not contemplate a registration system or service where the charity can register the raffle according to state and local law. For a small charity, the registration requirement of many states is a significant burden that cannot be overcome without a registration service. Without state by state registration, a charity cannot legally collect funds from a state where the charity or the event is not registered.

United State Patent Application Publication US 2008/0065512 to McHale et. al. discloses a method, system and program code that enables a nonprofit organization to manage its fundraising activities online. Again, this service does not contemplate a registration system. Without a registration system, there is a significant barrier to a charity wishing to comply with state and local laws because the charity must manage and create registration forms for each state where donations are to be accepted in order to comply with state and local laws. Many charities do not have the expertise or manpower to accomplish an effective registration process.

U.S. Pat. No. 7,247,095 to Nulph is directed to a method and system for marketing and game selection for lottery products. The Nulph patent includes a game selection device that includes a plurality of game types. The devices are directed to government run lottery games, and may be point of sale devices that are located in places such as restaurants or convenience stores.

United States Patent Application Publication 2005/0080713 to McHale et al. is directed to a method and apparatus for creating a catalog for an on-line charitable auction or fund raising event. As in the aforementioned prior art, the method and apparatus disclosed lacks a state and local registration component, which is a significant barrier to entry for many charities.

United States Patent Application Publication 2005/0171840 to Rinehart is directed to online commerce in buyer items with incidental free raffle tickets. As this system and method does not collect money in exchange for a raffle ticket the requirements of state and local laws differ.

### SUMMARY OF THE INVENTION

An object of the present invention is to streamline the charitable event process by providing a central location where the charity can register, manage, promote and run their charitable event.

Another object of the present invention is to provide an online location where a donor may enter a charitable event by donating through the online system.

Another object of the present invention is to provide an event registration service to the charitable entity.

Yet another object of the present invention is to provide a donor compliance service where the location of the donor is automatically compared with the registration status of the state where the donor is located.

Another object of the present invention is to provide each donor with a unique event ticket. The ticket may be electronic or hard copy or both.

Another object of the present invention is to provide a website where the charity can promote the charitable event.

Another object of the present invention is to provide a tracking service that compiles data on each donation provides reports on donations received and prizes awarded.

Yet another object of the present invention is to allow donors to set donation and notification preferences for future events run by particular charities.

Yet another object of the present invention is to randomly select one or multiple tickets, and distribute prizes to the winner(s).

Yet another object of the present invention is to provide an event reporting service, where income-reporting forms are generated for use with tax documents.

These and other objectives are achieved by providing a system for a managing a charitable event including a processor, with software executing thereon, and a website. The website receives entity information including, for example, contact and tax identification, and event information concerning a charitable event. A location may be selected via the website. The software creates at least one registration form for each location selected. The registration form is sent to a review authority for the corresponding location, and the software tracks the approval status of each location packet. A status of the approval process for each location is provided via the website. The website includes an event description including information about the entity and the event. Visitors may view the event description, select a billing location, and if said billing location is in an approved location, the visitor may purchase an online raffle ticket. The software further creates a unique raffle ticket for each raffle ticket purchased by each visitor, selects a winning raffle ticket for each prize, and notifies the owner of said winning raffle ticket.

Further provided is a method for creating and managing a charitable event, including the steps of providing a website, receiving, via the website, entity information, the entity information including contact and tax identification, and receiving, via the website, event information about a charitable event including one or more locations for the charitable event. The method further includes creating, via software executing on a processor, at least one registration form for each of the locations based on the entity information and the event information, sending, via software executing on the processor, each the registration form to a review authority for the corresponding location, and tracking, via software executing on the processor, an approval status of each registration form and setting the website to the status of each location according to the approval status. The method may also include creating, via software executing on the processor, a unique raffle ticket for each raffle ticket purchased by each visitor to the website upon verification that the visitor's billing location coincides with an approved location, and selecting, via software executing on the processor, a winning raffle ticket from a plurality of unique raffle tickets purchased by the visitors to the website.

### BRIEF DESCRIPTION OF THE DRAWINGS

FIG. 1 is a flow chart showing a high level overview of the system and method of the present invention.

FIG. 2 is a flow chart representing a fundraising campaign registration process and lifecycle of an event as shown in FIG. 1.

FIG. 3 is a flow chart representing a state registration packet creation process that is shown in FIG. 2.

FIG. 4 is a flow chart representing the tracking of registration mailings and the state review cycle shown in FIG. 2.

FIG. 5 shows how annual state filing fees are computed and processed.

FIG. 6 shows fund transaction flow.

FIG. 7A shows a high level overview of donation flow

FIG. 7B shows donation flow in detail.

FIG. 8A shows how the event is promoted to the affinity group.

FIG. 8B shows how the affinity group can attract others to the event.

FIG. 8C shows how website visitors are routed within the website.

FIG. 9 shows how funds are collected.

FIG. 10 shows how funds are disbursed.

FIG. 11A shows the annual tax filing document creation and delivery for the charity.

FIG. 11B shows the on demand option for the creation and delivery to the charity

FIG. 12A shows the annual tax filing document creation and delivery for the donor.

FIG. 12B shows the on demand option for the creation and delivery to the donor.

FIG. 13A shows the annual tax filing document creation and delivery for the winner.

FIG. 13B shows the on demand option for the creation and delivery to the winner.

FIG. 14 shows how transactions are turned on and off based on state approval.

FIG. 15 shows how the website qualifies each attempt to donate.

FIG. 16 shows how the website allows or denies donation by user location.

### DETAILED DESCRIPTION OF THE INVENTION

The present invention streamlines a charitable event, thereby making it possible for the charity to run an event over the Internet using one or more websites or phone/PDA applications. The charitable event may be a raffle format. One of multiple available format options is a 50/50 raffle.

By using the Internet as a platform to accept donations to enter the charitable event, the charity can have broader appeal and increased visibility of both the event and the charity. This increased appeal and visibility increases the potential amount for funds to be raised for the charity's cause. The present invention provides a central location where donors can browse content about the charity that discusses who the charity is, what the event is and what the charity is raising money for. This system allows the donor to keep track of the charity before, during and after the event. The availability of content about the charity can potentially increase the donor's desire to enter charitable event, because the content shows what the donation is used for.

In order to run the charitable event, the charity must register the event in each state where the charity expects to solicit funds. Presently, the task of registering in each state is difficult because of different state requirements for charitable events. The present invention streamlines the registration process by compiling the charity's information and then using that information to fill out a form as required by each individual state. Since many states have varying requirements, this process makes it very difficult for charities to run an event across state lines. The present invention provides the charity with a single data entry point for creating multiple state specific registration forms. The charity's information may be collected through previous IRS forms, for example form 990. The information may also be inputted into a generic form either hard copy or electronic. The information in the generic form can then be used to create a state registration packet including state specific registration forms.

Since each state has different information requirements and submission requirements, the registration service of the present invention includes filing of the event application or fund solicitation forms with the appropriate state offices. This includes generating a registration packet that the charity may view online through a secure login. In the event of a signature or notary requirement, one document is compiled to include all the required signatory or notary blocks. The charity can print this document. The document is signed and/or notarized and returned to the central office for processing and submission to each relevant state agency. The registration service also tracks the status of each event application, and automatically adjusts the system's ability to accept donations from a particular state based on the registration status.

Some states have specific forms or registration processes that allow a charity to register a high dollar amount event. State law sets the level of high dollar amount. In some states $10 is considered a high dollar amount.

The specific amount varies from state to state. For example, an event with $100 tickets and 1,000 tickets sold could be a high dollar amount event. The registration process allows the charity to create an event using a high dollar amount, and the registration system compiles a registration packet using the data previously collected by the system.

Some states have a limit on the number of events a charity can run each year. The registration service also has the ability to track the number of events the charity ran in the past within a particular state and then compare this with the limit each state sets on the number of events a charity is allowed to run. Before submitting the registration forms to the appropriate state body, the registration system will notify the charity if a state would be expected to refuse registration based on the number of previous events run in that particular state.

Each state may have a fee associated with registration of the event. The registration allows the charity to review the fees associated with each state, further the system collects the sum of all registration fees and then distributes payment to each selected state. The registration service further allows the charity to choose any number of states in which to run the event.

The present invention has a location where a donor may enter the event by donating to the charity. The location can be a website, but the system also has the capability to accept paper donations. When a donor wishes to donate by electronic means, the system asks for the billing information for the card. The system then compares the billing information, such as state or zip code with the status of the registrations. If the billing state is an un-registered state, the system refuses the donation. If the donor's billing location is one of the registered states, the system allows the donor to complete the donation.

The present invention also allows a donor to donate to multiple charities in one transaction. The donor may choose one or multiple events in which they wish to register. Once the donor chooses the events and sets the donation levels, the donor can initiate one transaction that charges the total donation amount across all charities. The system then distributes the donations to each charity based on the amount set by the donor.

The system also tracks donors who attempted to donate, but were refused because the donor's state was not registered. This information is included in the event reporting data so that the charity can see if individuals in un-registered states were unable to enter the raffle. This information can be used by the charity to determine if they would like to expand the number of registered states in a future event.

The system also allows website visitors to set notifications. For example if the application for event registration in Florida is pending, potential entrants from Florida will not be allowed to enter the event. These entrants may set notifications that will alert the potential entrant when the status of a particular state's registration has changed. In the example of a Florida entrant, if the application is approved in Florida, the system is updated to accept donations from Florida. Once the system is updated to accept these donations, the potential entrant(s) from Florida will be notified that they may enter the event. This example is only meant to demonstrate one of the many possibilities of notifications. One of skill in the art would understand that other examples of notifications are possible in order to communicate with past, potential, future and present donors.

In addition to automatic notification, the donor will have the option to set a number of donor preferences. For example a donor may wish to automatically enter events for one or multiple charities. When the charity creates a new event the donor can set their preference to automatically be charged the requested donation amount. The donor may set total donation limits. Donation limits may also be set per charity, or per a particular timeframe. The donor can change donation preferences. The donor also has the option to send a notification of when an automatic donation will be initiated. For example, a donor may wish to receive a notification 24 hours prior to the initiation of the charge for the donation. This would allow the donor the opportunity to adjust their preferences before they are charged for the donation. The 24-hour period is used only for example purposes, and one of skill in the art would understand that there are many options to customize the notifications and preferences.

Each donor will also be provided with an annual donation receipt. This receipt will itemize donations to tax exempt status organizations for use with income tax reporting. This makes it easier for the donor to track all of their annual charitable donations in one place, and the streamlined process is an incentive for the donor to donate through the online system for all their annual charitable contributions.

The event can be set up to accept micro or macro donations. The charity can determine the fundraising goals of the event and scale the donation entry level accordingly. For example a charity may wish to raise $100,000 by setting the donation level at $1 and accepting 100,000 entries. If a donor wished to donate $100 to a single charity, the system would allow the donor's $100 to be separated as $1 going towards the event for purposes of generating a ticket, the remaining $99 would go directly to the charity. One of ordinary skill in the art would understand that there are many possibilities of donation levels and entry limits that can be chosen by the charity and/or donor. Some states set a dollar amount limit on donations. The system automatically complies with state requirements by only accepting donations that meet the dollar value requirement set by each state.

In order to offer incentives for participation in the event, the charity may choose to offer prizes to the winners. For example, a charity may wish to provide the winner of the event a pre-paid vacation to Europe among other possible prizes. Donors have an incentive to donate a relatively small amount of money to win a prize with a much higher value than the donation. The odds of winning may also be pre-determined. In the previous example of a $1 donation, the odds would be 1/100,000. These odds are significantly better than a typical state lottery, even though the cost of entry is similar. The examples provided are intended to demonstrate the invention and the examples are only one of many possible event structures.

In order to run a charitable event, many states require a “no purchase necessary” option. The present invention includes a website explaining the process of how to enter the charitable event without donating a monetary sum. The present invention also accepts entries according to the process for entering without donating money.

In order to effectively run the charitable event, event tickets must be generated. The present invention includes a ticket generator that creates a unique event ticket once a donor has donated through the online system. The ticket may be electronic, hard copy or both. The event will have an entry deadline or entry cap, and after the deadline/cap has passed, the acceptance of entries will close. Once the entry window has closed, the system will choose one or multiple event winners. The event winners will be selected from the tickets assigned by a donation and the tickets created through the “no purchase necessary” process.

The event ticket may also include event information such as, event rules, event identifiers, legal disclosures, state specific disclosures, drawing date(s) and encrypted information to identify the authenticity of the ticket. The ticket may include other information relevant to the event, and the proceeding list is not exhaustive of all possible combinations of information.

Once one or multiple winners are chosen, prizes are distributed according to the pre-determined rules of the event. When an individual wins a prize, there may be a requirement that the value of the prize is reported to state and/or federal tax agencies. The system will provide each winner with a winnings statement that is in an acceptable format to be used with tax documents for each state or federal tax agency.

The present invention also includes a reporting service. This reporting service keeps track of the location of each donation and the distribution of prizes. Should a state or federal body require funds solicitation information, the system will allow the charity to easily report donations and prize distribution according to state or federal reporting requirements.

In addition to this tracking service another object of the present invention is to provide a tracking service that compiles data on each donation and provides reports on donations received and prizes awarded. The data can be used for future charitable events. The system will notify a previous donor that the charitable entity is running another event. This will encourage the donor to donate to the charity through upcoming events. Communicating early with past donors creates an affinity group of individuals or corporations who have shown an interest in the charity. By using the system to communicate with the affinity group, the system makes it easier for the charity to create a repeatable event. The repeatability of the event gives the charity a steadier donation income stream.

The system can also provide a platform for the charity to communicate with past donors or the affinity group. Communicating with the donors keeps the donors feeling involved with the charity and the donors feel more involved with the charity. This in turn leads to the donors to continue to participate in future fundraising events through the online system. This also makes the event repeatable and provides a steady fundraising income stream for the charity.

The event may have an entry cap that limits the total amount of entries. The system can provide an early entry system where past donors are allowed to enter regardless of the entry cap on the event. The system can also provide an early registration window that is open to past donors. This allows the charity to keep the affinity group involved in as many events as possible. The system builds trust with the affinity group, and this trust builds appeal and further donations to the charity.

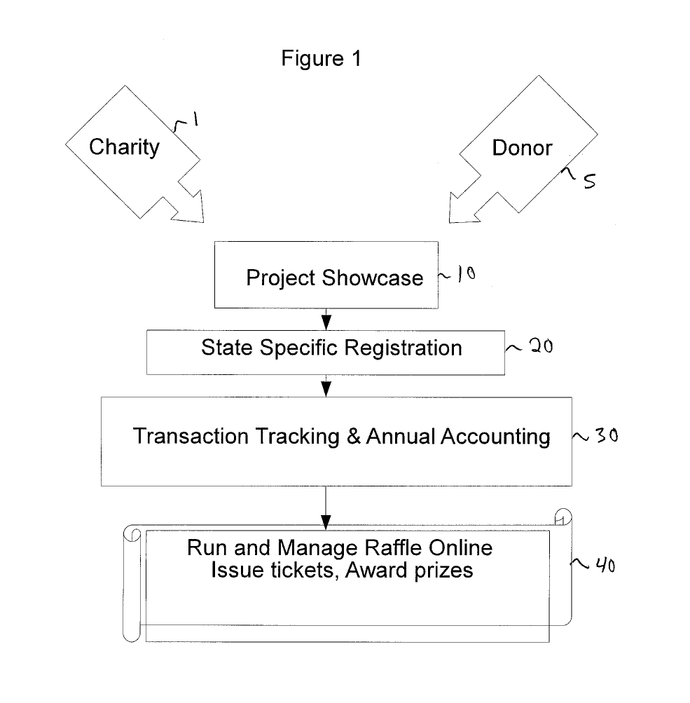

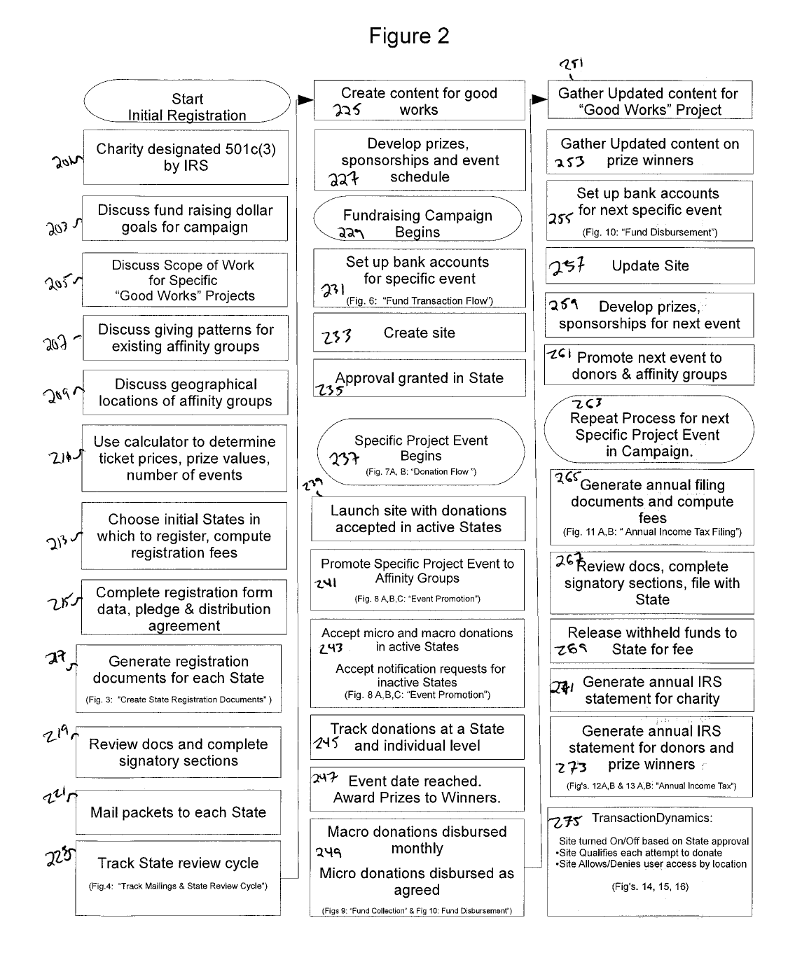

FIG. 1 shows an overview of the system and process for creating, managing, and running a charitable event using the system of the present invention. The process is initiated when the charity creates a project showcase 10. This showcase 10 can include details of the fundraising goals as well as who/what will benefit from the charitable event. The showcase 10 may also explain the prizes associated with the event as well as possible odds of winning a prize. This project showcase 10 is what a potential donor will view when they visit the website for the first time. The showcase 10 is intended to attract potential donors 5 to the cause and turn the donor 5 into a member of the “affinity group” of the charity, where the affinity group is a contact list of people interested in the events and activities of a particular charity. FIG. 1 further illustrates a state specific registration 20. This registration process involves creating and filing the necessary forms to register the raffle in a number of target states. The registration process is further detailed in FIG. 2.

The transaction tracking & annual accounting process and/or software module 30 shown in FIG. 1 is the process by which donations are reported according to individual state and federal tax laws. For example, some states may require a detailed accounting of how much money was raised from the state and what prizes were given to residents of that state. Transactions can be tracked on a state-by-state level to make this detailed accounting possible. The detailed and complete nature of the tracking and accounting portion of the system help create a reputation of compliance with laws. The tracking and accounting also establishes trust between the charity and donor, charity and event Management Company and ultimately donor and event Management Company. The trust between the donor and event management company makes the donor more likely to repeatedly donate to charities running events with the event management company. The system's ability to have a project showcase, state specific registration and a tracking and accounting system makes it possible to run and manage raffle online 40 as shown in FIG. 1. Some elements to managing the raffle include issuing tickets and awarding prizes.

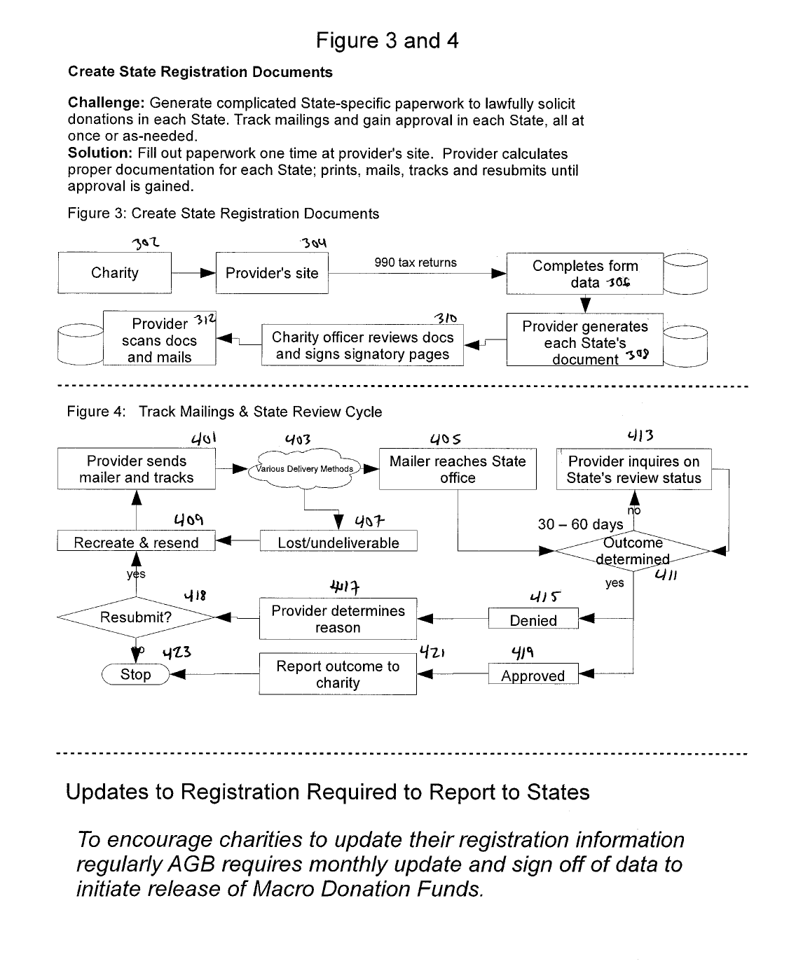

FIG. 2 shows a lifecycle 200 of the fundraising event, including the registration process. In order to register the charitable event, the organization must be an IRS designated 501c(3) entity. The event management company and the charity will discuss the fundraising goals in terms of dollar amount for the campaign (203). The scope of the good work is also discussed to determine what a donor's money will be used for (205). This content can also be included in the project showcase. There can also be a determination of the existing giving habits for the charity's current donors (207); also the geographical location of donors is important to determine potential states to register the event (209). Based on the fundraising goals, ticket prices, prize values and the number of events are calculated to determine the structure of the event(s) (211). Initial states are selected in which to register, and registration fees are computed (213). Registration form data is collected along with pledge and distribution agreements (215). Once the target states are determined registration packets are created for each state specific registration form or format (217). The registration packet creation is further detailed in FIG. 3.

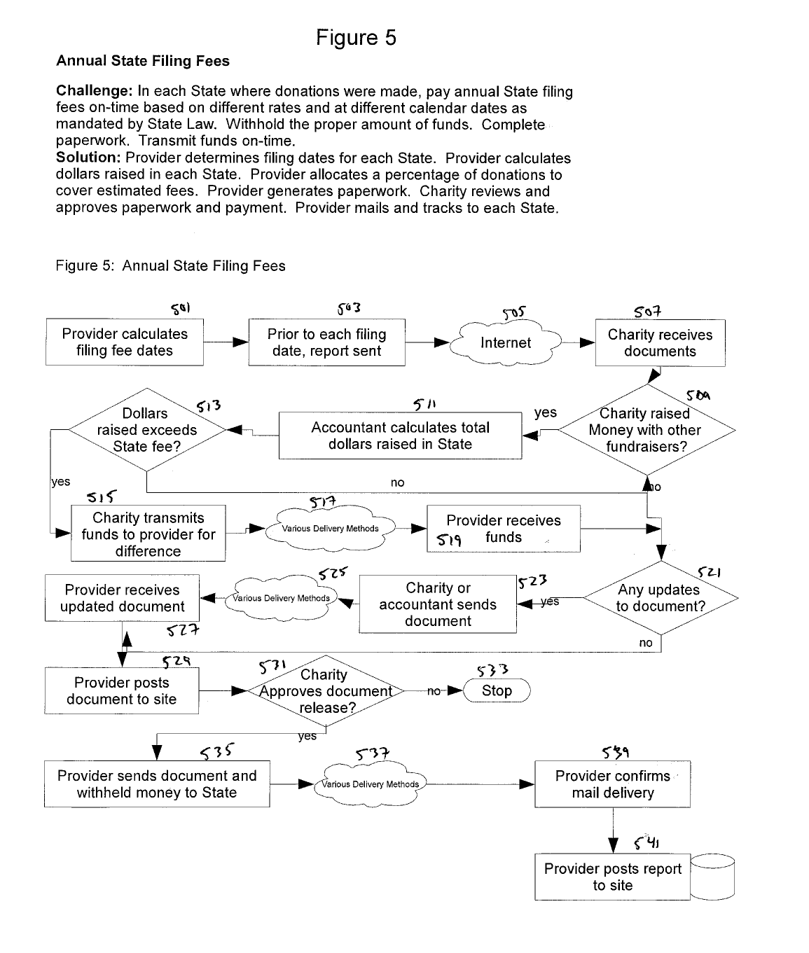

Once the registration packets are created, some states require signatures of one or more officers/members of the 501c(3) entity. To comply with this requirement, signatory block pages are sent to the appropriate person and they are signed and returned to the event management company (219). Once the packets are completed and signed, they are sent to each state in the format required by individual state laws (221). The status of each state is tracked by the system, and donations are refused from individuals in a state that has not yet approved registration (223). Once a state is approved, donations may be accepted from the approved state. The tracking of the mailings and the tracking of the approval of registration is detailed in FIG. 4.

Content for the project showcase website is also created to promote the charity and the event (225). The showcase website can convey compelling messages to potential donors that will make these persons want to enter the raffles with a donation(s) through the website. Prizes, sponsorship and event schedules are also determined for one or multiple charitable events (227). This information can also be included in the content of the project showcase. The fundraising campaign begins, and in order to track and manage the donations a bank account can be created for the specific event (229). Also, for the event website to begin accepting donations the website for the event is posted and approval must be granted in one or multiple states (233-235). The website may be posted prior to approval in order to attract attention to upcoming events, but donations may not be accepted until registration is approved in at least one state or there are one or more state approvals obtained by the charity prior to establishing a project showcase.

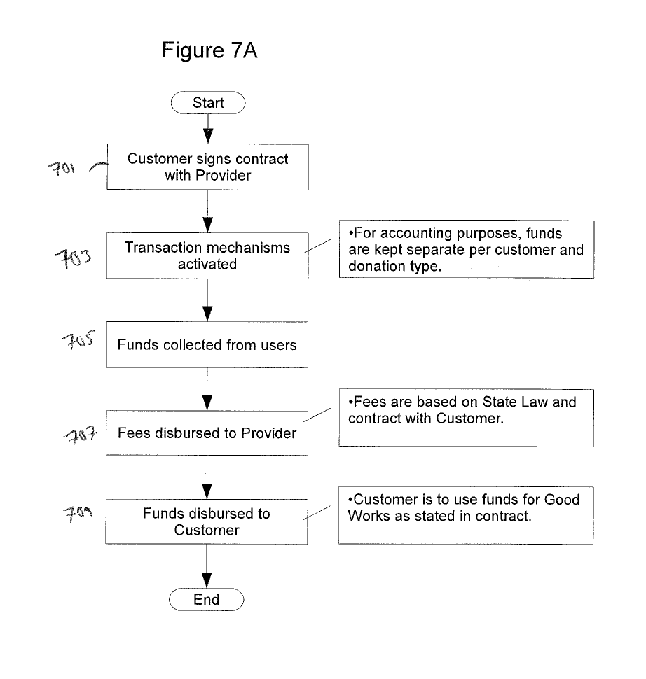

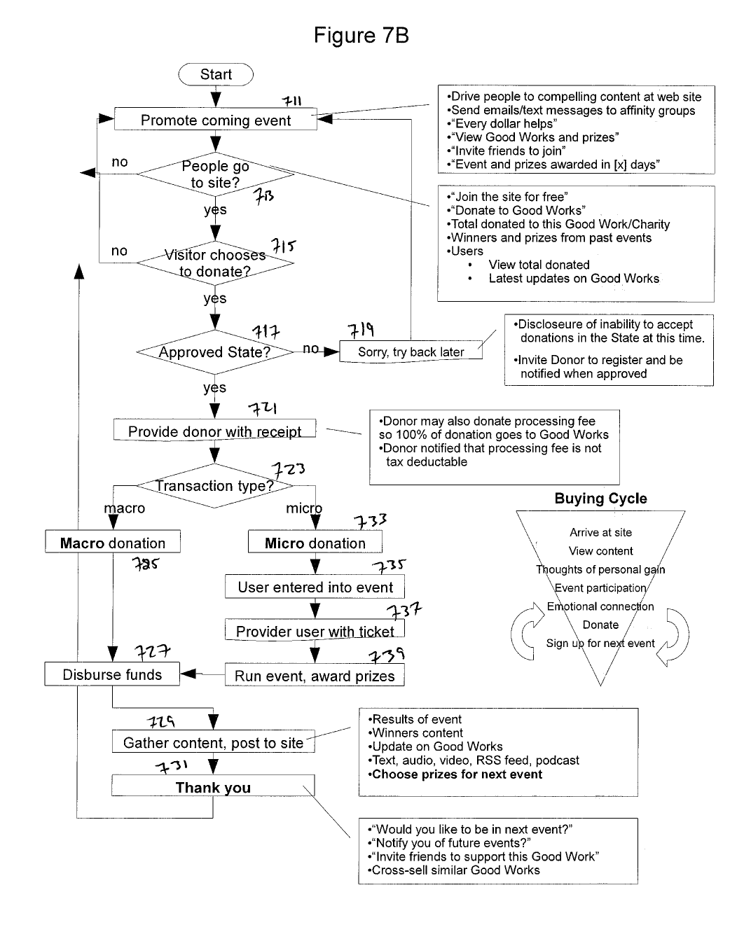

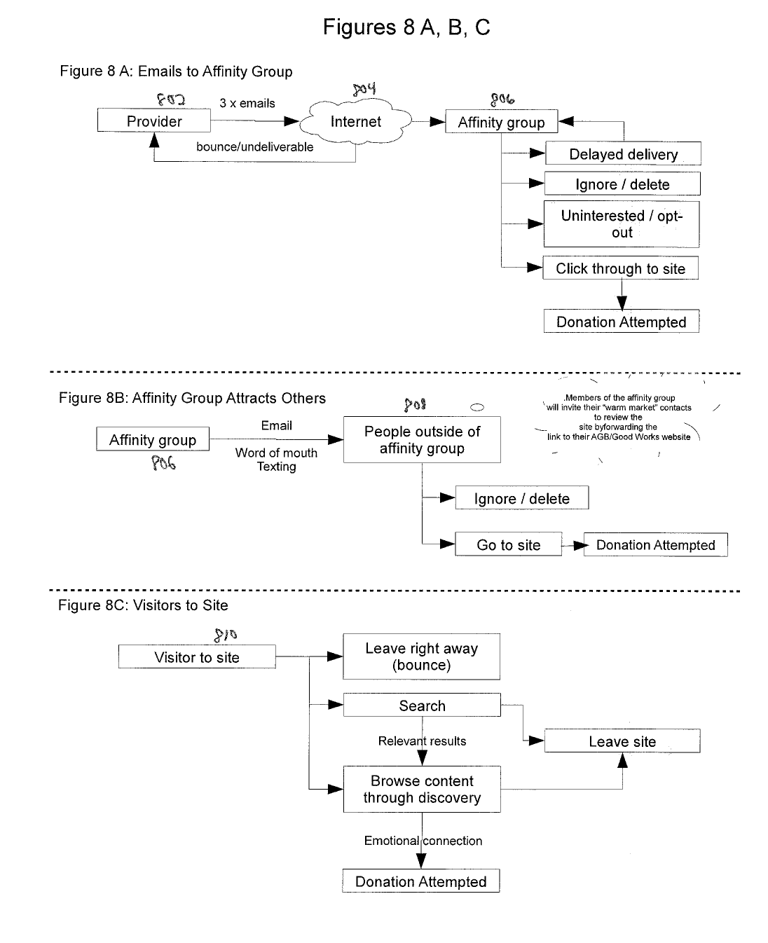

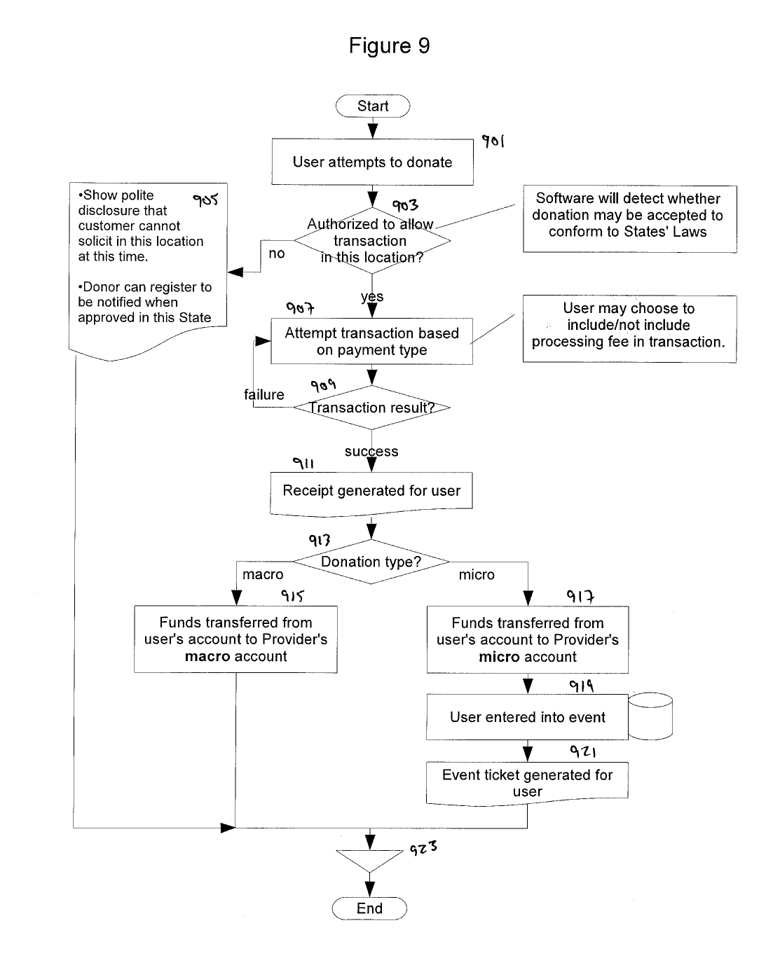

In order to track the funds for the event, bank accounts may be set up to manage the funds (231). FIG. 6 shows the fund and transaction flow associated with the creation of a bank account for the event. The fundraising campaign can begin once one or more states have approved the event. FIG. 6 shows the fund transaction flow associated with the bank account(s). FIGS. 7A-B show two examples of the flow of donations through the system in further detail. As shown in FIG. 1, a website for the specific fundraising project or event is launched to accept donations from approved states (239). The event is also promoted to the affinity group or contact list of the charitable organization (241). See FIGS. 8A-C for more detail on promoting the event. Once a donor decides to donate, the system can accept both micro and macro donations (243). Micro donations are used to enter the raffle or event. Macro donations are contributions to the charity where the donor does not receive a raffle ticket in return. See FIG. 9 for a more detailed explanation of the system for fund collection.

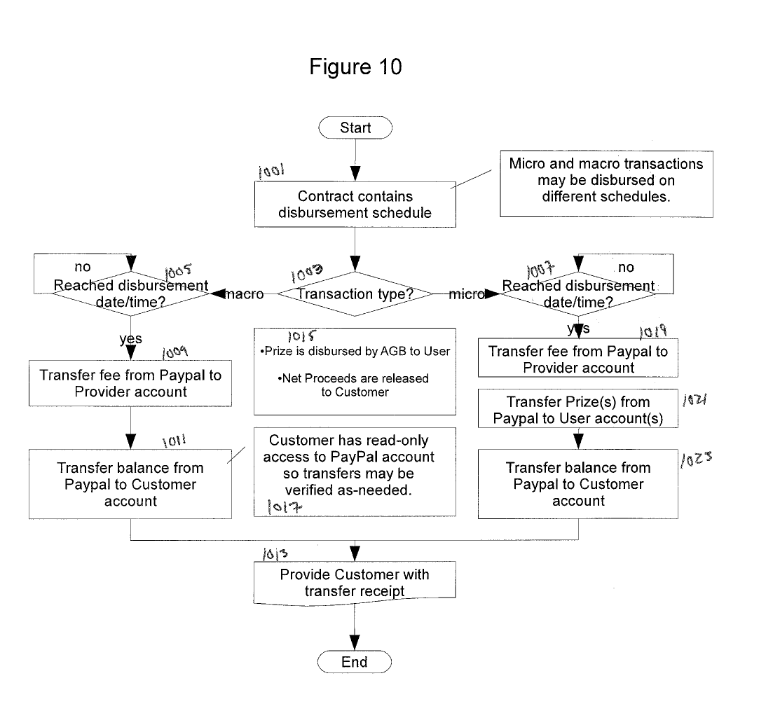

Donations are tracked on both a state and individual level in order to allow for comprehensive reporting to state agencies and individuals for tax or other purposes (245). Once the event date is reached, winners are selected and prizes are awarded (247). Funds can now be disbursed accordingly. Macro donations are distributed monthly, but may also be distributed at a different schedule as necessary (249). Micro donations, which were used to enter the event or raffle, are distributed as per an agreement with the charitable entity. See FIG. 10 for detail on fund disbursement. FIG. 2 further shows that more content is gathered for future good works as well as events (251). This updated content also can be publicized to donors or other interested persons on what the money was or will be used for. Bank accounts are set up for the next event. FIG. 6 shows more detail of the fund transaction flow. The website is also updated with the new content, prizes are gathered, and the event is promoted to the affinity group (253-261). The affinity group may have grown because of the event and the participation of new donors. The process for a new event campaign can be repeated (263).

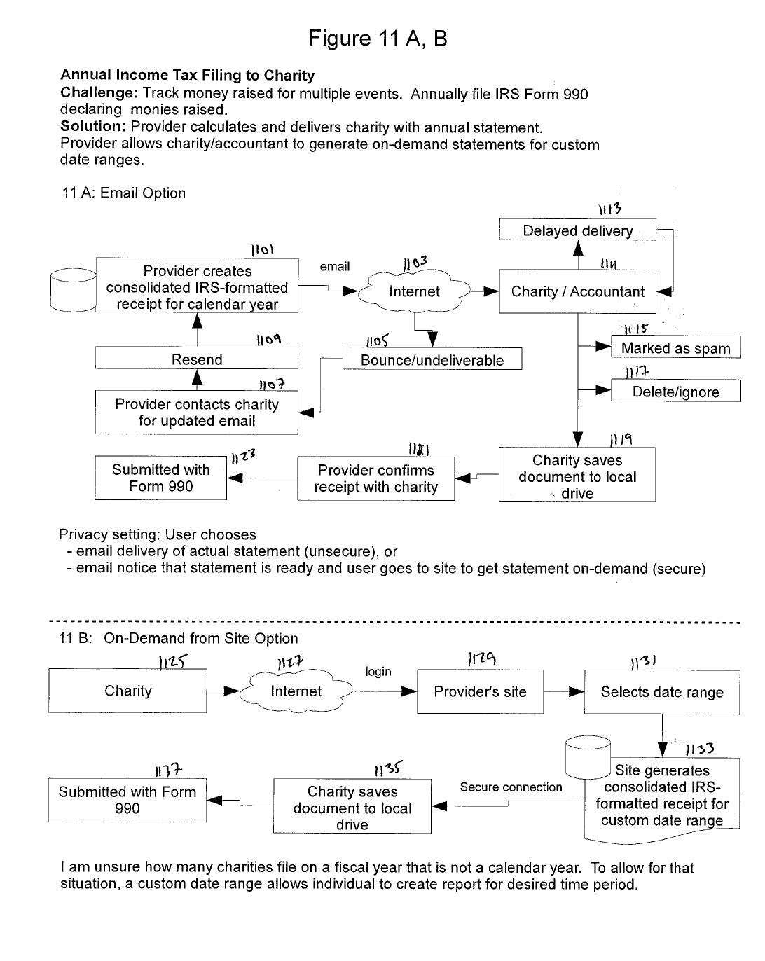

FIG. 2 further shows that annual filing documents are created and state fees are computed, see FIG. 11-13 for more detail on this part of the system (265). These documents are reviewed, and the appropriate member or officer of the charitable entity completes the signatory portions of each document (267). Funds withheld for each state are released, and an annual tax statement is generated for the charity (269). This document is preferably generated in IRS or state tax agency compatible format. Annual statements for donors and event winners are also generated in IRS or state tax agency compatible format (271). These documents are sent to the donors and event winners (273). See FIGS. 11-13 (A and B) for more detail on the annual income tax reporting.

FIG. 3 Shows registration packet creation. The charity 302 can go to the provider or raffle management company website 304 and enter their form data 306. It is possible to use a previous 990 form to enter form data. The provider then uses this data 306 to generate a state specific filing document. The charity reviews the documents and completes the signatory portions if necessary (310). The provider then stores a copy of these documents and sends them the appropriate state agency in the format required by the agency (312).

FIG. 4 shows the tracking of mailings and state approval. The packets generated for registration are sent to the appropriate state agency (401-405). FIG. 4 shows various delivery methods 403 including US Postal Service as an example, but other delivery methods may be used. For example, United Parcel Service, Federal Express, DHL and other delivery companies may be used. When the registration packet is sent, if it is undeliverable or lost, the system includes the process of re-sending the packet (407-409). Once the state office receives the mailer, the registration must be either approved or denied (411). If necessary, the provider will follow up with the state agency on the status of the application(s) (413). If the application is denied, the provider determines the reason and decides if the documents will be edited and re-submitted (415-418). The charity may be consulted on the decision to edit and re-submit as necessary. If approved, the provider notifies the charity, and the registration process for the particular state is completed (419-423). Some states require updates to registration. The charity provides this information to the provider. In order to offer an incentive for regular reporting, the provider may require the charity to update the registration data in order to release funds.

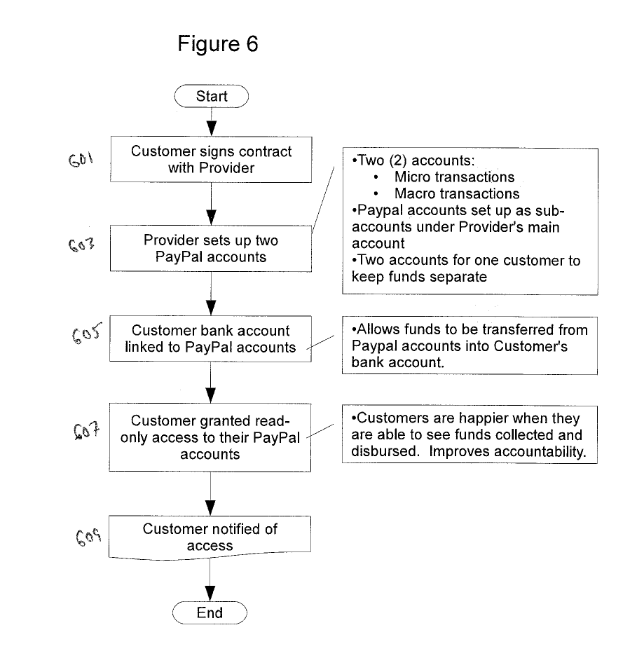

FIG. 5 shows how annual state filing fee are calculated and disbursed. Each state may require different fees at different schedules. Each state may also require different percentages of donations withheld. The provider calculates the appropriate state fees and withholding rates (501). A percentage of donations is withheld to cover estimated fees. The provider creates paperwork for the fee calculation, this paperwork is reviewed by the charity, and the provider sends and tracks the paperwork on a state-by-state basis. As shown in FIG. 5, the provider calculates filing fee dates and generates a report prior to the fees being sent. The documents are sent to the charity (503-507). This may be done over the Internet as shown in FIG. 5, but other methods of sending the documents to the charity may be used. If the charity raised money with other events, the total dollars raised in each state are calculated (509-511). The total raised may exceed the state fee, if so, the charity transmits funds to the provider for the difference (513-515). The funds may be transmitted through mail, an online transaction company such as Pay Pal, credit card, bank transfer or other appropriate methods of fund transfer (517).

The provider receives the funds and determines if it is necessary to update any documents, if so, these documents are sent to the provider (519-527). The provider posts the documents and the charity reviews and decides if they will approve document release (529). If the document release is approved, the provider sends the documents and withheld money to the state (531-535). The figure shows USPS, but other forms of sending the documents may be used (537). The provider confirms the delivery of the documents and funds and a corresponding report is posted (539-541).

FIG. 6 shows fund transaction flow. Once the charity or customer decides to run an event with the provider, two accounts may be set up to handle micro and macro donations (601-603). Micro donations are typically used to enter the raffle event, whereas macro donations are charitable contributions above the entry amount. The figure shows Pay pal accounts being used, however any account that allows online transactions may be used. There are two online transaction accounts used to keep fund types separated. Each online transaction account is linked to the customer bank account so that money may be transferred to the charity according to an agreed upon distribution schedule (605). The charity may be granted access to their online transaction account (607). This access may be set as read only, and the customer is further notified of the opportunity for access (609).

FIG. 7A shows how funds are collected in a high level view. Once the customer or charity decides to run an event with the provider, transaction methods are activated in order to receive donations and account for donations and their origin (701-703). Funds are collected from donors (705). The provider withholds sate-filing fees, and funds are distributed to the customer or charity (707-709).

FIG. 7B shows a detailed flow of donations and how funds are collected. The website and other means may be used to promote the charity's event (711). The website can include compelling content about the charity, send e-mails or SMS messages to the charity's past donors, display the charity's good works, display event prizes, encourage donors to have their friends join, and have a countdown to when prizes are awarded. When a potential donor goes to the website, they are prompted to join the website for free (713). A potential donor can see, the total donated to a charity and winners and prizes of past events. A registered user can see their donation totals as well as view updates from past good works the user may have supported. If a visitor chooses to donate, the website will track the approval status of the donor's state (715-717). If the visitor's state is not registered, the donation will be refused, and the visitor will be able to set alerts to notify the visitor when their state is approved (719). Alerts can be SMS and e-mail as well as others. If the donor's state is approved, the donation is accepted and the donor is provided with a receipt (721). The donor has the option to add the processing fee to the donation so the entire donation goes to the charity. The donor is notified that the processing fee is not tax deductible.

If the transaction is a macro donation, the money is received and disbursed to the charity (723-727). If the transaction is a micro donation, the donation is used to enter the event (733-735). The user is provided with a ticket, the raffle is run and the event winner(s) is/are notified (737-739). Funds are disbursed to the charity (727).

Content on the event and updated information for the charity is gathered and posted on the website (729). Content may include results of the event, winners of the event and updates on the charity's good works. Text, audio, video and RSS and other means of promotion may be used to disseminate information about the charity and the event. Prizes for the next event may be chosen as well. Donors are thanked for participating in the event and are asked if they wish to participate in the next event (731). Donors may also receive notifications of upcoming events, be encouraged to invite friends and receive cross promotions for related events or charities.

FIG. 8A shows how the event is promoted to the affinity group. The provider 802 will send a message to members of the charity's affinity group 806. If the e-mail bounces or is undeliverable, the provider will try three times to send the message. The action of the affinity group member can be tracked to determine if the delivery is delayed, if the message is ignored or deleted, if the affinity group member decides to opt out or is not interested. If the affinity group member clicks through to the website from the e-mail or promotion message, the provider will track this as well.

FIG. 8B shows how the affinity group 806 can attract others to the event. Affinity group members are encouraged to promote the event with their friends and other contacts 808. This can be done through word of mouth or emails. These messages can be ignored by the contacts of the affinity group member, or the new contact may decide to visit the website attempt a donation. Should a donation be attempted or accepted, this new contact is added to the affinity group.

FIG. 8C shows how website visitors 810 are routed within the website. Individuals may also visit the website on their own. These individuals could view the website and leave right away. The individuals may also search relevant content and browse the results. If the individual does not whish to donate, they may leave the website, however the content on the website is meant to create an emotional connection between the charity and the potential donor, causing the donor to donate funds to support the charity and the charity's good works.

FIG. 9 shows how funds are collected. When a user attempts to donate, the system determines if the transaction is authorized by state law according to registration status (901-903). If the transaction is not authorized, a polite disclosure stating that the transaction is not authorized is shown (905). Further, the potential donor has the option to register for notifications as to when the particular state or transaction is authorized. The transaction is attempted based on payment type and the donor has the option to include the processing fee in the donation. If the transaction fails, the potential donor is notified and prompted to try again (907-909). If the transaction is a success, a receipt is generated (911). If the donation was a macro donation, the funds are placed in the corresponding macro account (913-915). If the donation was a micro donation, the funds are placed in a micro account (917). The user is also entered in the event and a ticket is generated (919-921).

FIG. 10 shows how funds are disbursed. The specific fund disbursement schedule may be customized to meet the needs of the particular event and/or charity. The schedule can be contained in the contract between the provider and the charity (1001). There can be different disbursement schedules for micro and macro donations. In order to properly disburse funds, the type of transaction is first determined, then the disbursement date/time is determined based on the agreed upon schedule (1003-1007). If the transaction type is a micro donation, the provider fee is transferred from the online transaction account to the provider's account, prizes are transferred to the user(s) account and balance of funds are transferred to the charity's account (1007, 1019-1023). In the case of a macro donation, prizes do not need to be transferred to a user, because the macro donations are separate from the event/raffle funds (1005, 1009-1011). Once a transfer is completed, the charity/customer is provided a transfer receipt (1013).

FIG. 11A shows the annual tax filing document creation and delivery for the charity. The provider creates a consolidated IRS formatted receipt for the calendar year (1101). This receipt can be sent over the Internet to the charity, and mail, fax or other means of communication can be used (1103). If the message is not deliverable, the provider contacts the charity for an updated e-mail address, physical address, fax number or other (1105-1109). The charity saves this document for use with tax reporting (1119). The provider confirms the receipt of the document with the charity, and the charity may use the receipt for income tax reporting on the 990 form (1121-1123).

FIG. 11B shows the on demand option for the creation of an annual tax-filing document. The charity may log in to the provider's website and select a date range (1125-1131). The provider website generates an IRS compatible receipt for the selected date range (1133). The document can be saved locally by the charity for use with the Form 990 submission (1135-1137).

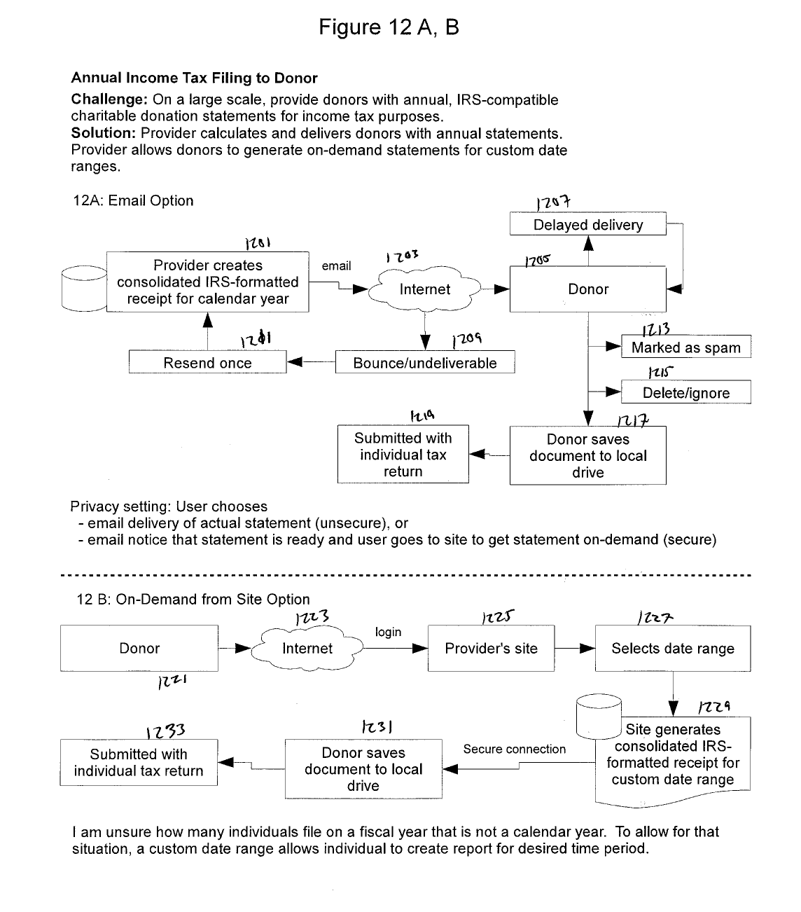

FIG. 12A shows the annual tax filing document creation and delivery for the donor. The provider creates an annual tax filing receipt and sends the receipt to each donor (1201-1205). The document can be sent through e-mail as shown in the figure, but other means of communication such as fax and mail may be used. If the communication is undeliverable, the system attempts to re send the document (1209-1211). The donor may mark the message as spam or choose to delete it entirely (1213-1215). The donor can save the document and use with their individual tax filing (1217-1219).

FIG. 12B shows the annual tax filing document delivery through an on demand option. The donor may log in to the provider's website and select a date range (1221-1227). The provider website generates an IRS compatible receipt for the selected date range (1229). The document can be saved locally by the donor for use with individual income tax reporting (1231-1233).

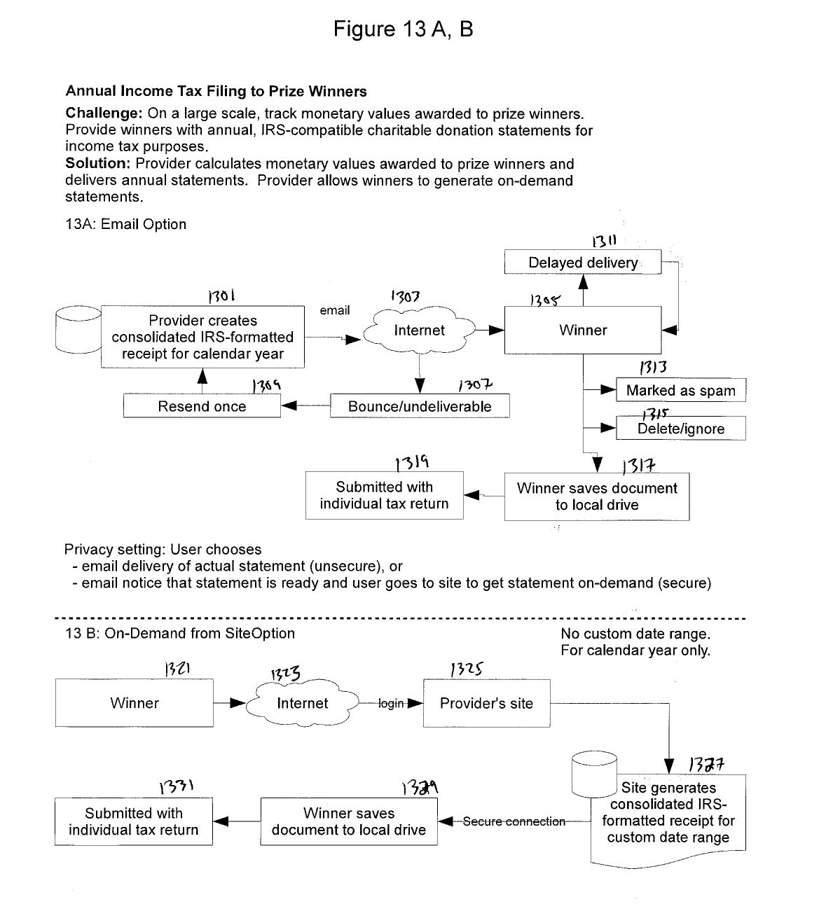

FIG. 13A shows the annual tax filing document creation and delivery for the event winner(s). The provider creates an annual tax filing receipt and sends the receipt to each winner (1301-1305). The document can be sent through e-mail as shown in the figure, but other means of communication such as fax and mail may be used (1303). If the communication is undeliverable, the system attempts to re send the document (1307-1309). The winner may mark the message as spam or choose to delete it entirely (1313-1315). The winner can save the document and use with their individual tax filing (1317-1319).

FIG. 13B shows the on demand option for tax filing document creation and delivery. The winner may log in to the provider's website and select a date range (1321-1325). The provider website generates an IRS compatible receipt for the selected date range (1327). The document can be saved locally by the winner and used with individual income tax reporting (1329-1331).

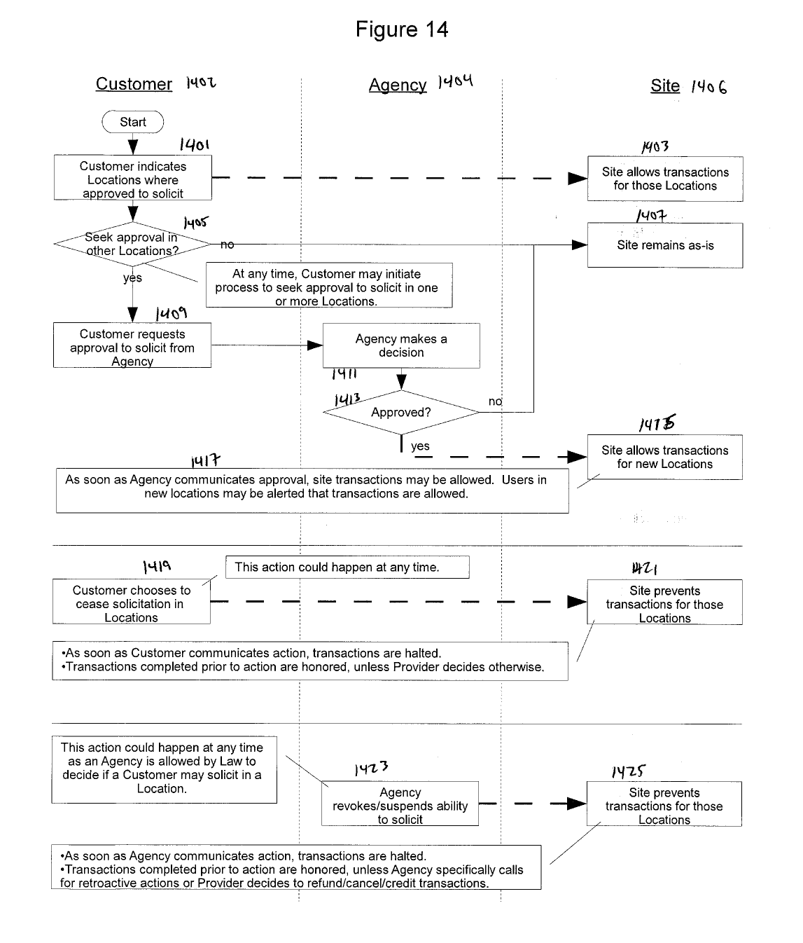

FIG. 14 shows how transaction acceptance is turned on and off based on state registration status. The customer or charity indicates to the provider, which states they are authorized to accept transactions (1401). The website is updated to allow these transactions (1403). If the customer/charity 1402 decides to solicit funds from other states (1405), the customer/charity seeks approval from individual agencies 1404 through the registration process described above and in FIGS. 3 and 4 (1407). When the agency makes a decision, the site 1406 is updated (1413). If the agency denies the request, the site remains the same (1407). If the agency approves the request, the site is updated to accept transactions from that location (1415). Users from the newly added location are updated on the approval status of their location, and are told that they may now participate in the event/raffle (1417). The customer/charity may also choose to halt transactions from a particular location (1419). Should the customer/charity decide to do so, the website is updated to deny the particular location(s) (1421).

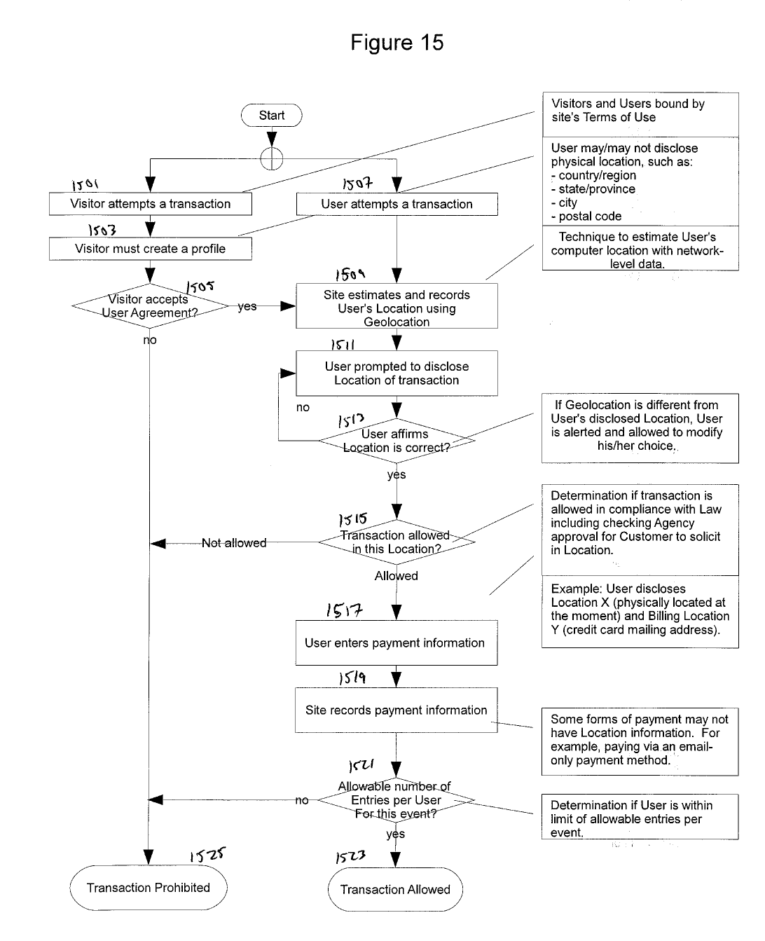

FIG. 15 shows how the site qualifies each attempt to donate to ensure that donations are only accepted from approved locations. When a user attempts a transaction, the website estimates and records geo location data (1507-1509). The user is prompted to disclose the location of the transaction and then affirm the location is correct, if the user does not affirm, the user is prompted to re-enter the location (1509-1511). The website determines if the location is allowed (1515). If the location is allowed, the website prompts the user to enter payment information, which is recorded by the website (1517-1519). The website determines if the user meets the limits of number of transactions per user for the event (1521). If the above conditions are met, the transaction is accepted (1523). The process is very similar for a visitor who does not have a profile with the website. Before the visitor's location is determined, the visitor is prompted to create a profile and accept the user agreement (1501-1505). The visitor is now a user and the process proceeds with the determination of the user's location. If the visitor does not accept the user agreement, the transaction is prohibited (1525). If the location is not allowed, the transaction is prohibited. If the user exceeds the number of entries per event, the transaction is prohibited.

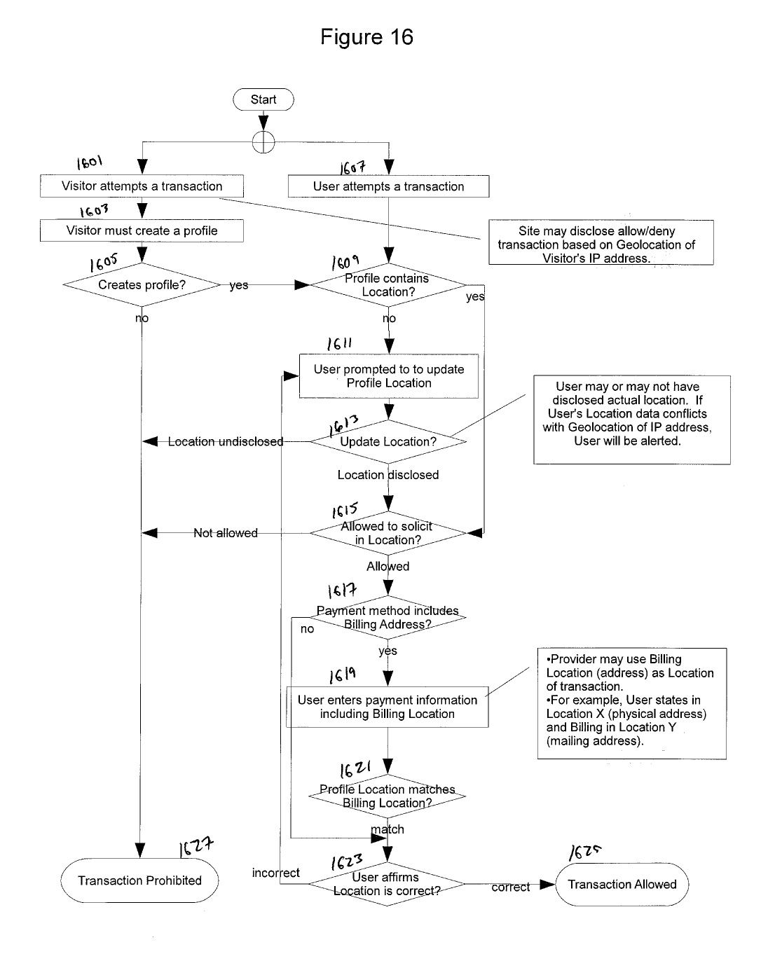

FIG. 16 shows how the site allows or denies user access by location on each attempt to donate to ensure that donations are only accepted from approved locations.

The aforementioned flow charts show elements of the process of running, promoting and managing a charitable event. The exact order of the elements is not dictated by the flow chart, and one or multiple elements may be moved or removed in the timeline of the event as necessary for the circumstances or needs of the event.

What is claimed is:

1. A system for a charitable event, comprising:
a processor with software executing thereon, said software in communication with a website;
said website receiving entity information, said entity information including contact and tax identification;
said website receiving event information about a charitable event;
data indicative of one or more locations for the charitable event selected by a user;
said software creating at least one registration form for each of the locations based on said entity information and said event information, wherein each said registration form is sent to a review authority for the corresponding location;
said software tracking an approval status of each registration form and setting the website to the status of each location according to the approval status;
said website including an event description, said event description displaying information about the entity and the event, said website allowing a visitor to view said event description, said website further allowing the visitor to select a billing location, if said billing location is in an approved location, said website allowing the visitor to purchase an online raffle ticket;
said software creating a unique raffle ticket for each raffle ticket purchased by each visitor; and
said software randomly selecting a winning raffle ticket for each prize, and notifying the owner of said winning raffle ticket.

2. The system according to claim 1, wherein said website receives an IRS Form 990, said software using the entity information contained in the IRS Form 990 to complete at least one registration form.

3. The system according to claim 1, wherein said website displays instructions and terms for submitting a no purchase necessary raffle entry and receives said no purchase necessary raffle entry; and wherein said software generates a unique raffle ticket for said no purchase necessary raffle entry and sends said raffle ticket to the entrant according to the instructions and terms.

4. The system according to claim 1, wherein said website displays a service fee that is charged for each raffle entry, said website allowing said visitor the option of donating the amount of said service fee to the entity in addition to the raffle price.

5. The system according to claim 1, wherein said event information comprises at least raffle prizes, raffle drawing date, and the cost of each ticket.

6. The system according to claim 1, wherein said website stores entity information.

7. The system according to claim 1, wherein said website prompts a visitor to create an account, said account comprising a user name, password, and contact information.

8. The system according to claim 1, wherein each said registration form is completed according to legal requirements for registration in each location selected by said user.

9. The system according to claim 1, wherein, said software creates a signatory packet, said signatory packet comprising signature blocks for each registration form for each location selected by the user;
wherein said signatory packet is sent to the user, said user signing each signatory block and returning said signed signatory packet, said signed signatory packet is divided into location specific signed signatory packets, each said location specific signed signatory packet is included in each location registration packet.

10. The system according to claim 1, wherein said registration form formatted according to a format accepted by each location selected by the user.

11. The system according to claim 1, wherein said registration form is sent with a delivery service that uses with a delivery status notifier, said software automatically updating the status of each registration form when said registration form is delivered to the review authority.

12. The system according to claim 11, wherein said delivery status notifier is one of a tracking number and a delivery confirmation number.

13. The system according to claim 1, wherein, if said billing address is not in an approved location, said website displays a message notifying the visitor of the status of the location.

14. The system of claim 13, wherein said visitor is prompted to enter contact information, said software automatically notifying the visitor when the approval status of the location changes.

15. The system according to claim 1, further comprising:
said software creates a location specific report for each location selected by the user.

16. The system according to claim 15, wherein said location specific report comprises at least total funds raised in the location, prizes awarded in each location and the value of each prize awarded in the location.

17. The system of claim 1, wherein said software creates a registration cost summary, said cost summary identifying the fees and costs associated with registering in each location, said registration cost summary available for the user to view on the website.

18. The system of claim 1, wherein, if said billing address of said visitor is not in an approved location, the visitor is notified of the status of the location.

19. The system of claim 1, wherein the website receives donations of funds to the entity in addition to the purchase of a raffle ticket.

20. The system of claim 1, wherein the visitor is required to enter e-mail addresses for others before being allowed to complete the purchase of a raffle ticket, said software sending an e-mail to said e-mail addresses, notifying the recipient of the raffle.

21. A system for a charitable event, comprising:
a processor with software executing thereon, said software in communication with a website;
said website receiving entity information, said entity information including contact and tax identification;
data indicative of one or more locations for the charitable event selected by a user;
said website displaying the filing fees required by each location selected by the user;
if said user accepts the filing fees, said user confirming the at least one location selected;
if said user refuses the filing fees, said user requested to edit their choice of at least one location;
said software compiling said information about said entity and creating at least one registration form for each location selected by the user;
each said registration form is sent to the review authority of each location, said software tracking the approval status of each registration form and setting the website to the status of each location according to the approval status;
said software creating a unique raffle ticket for each raffle ticket purchased by each visitor via the website;
said software randomly selecting a winning raffle ticket for each prize, and notifying the owner of said winning raffle ticket.

22. A system for running a charitable event, comprising:
a processor with software executing thereon, said software in communication with a website;
said website accepting online payment for raffle donations from a website visitor;
said website further accepting online payment for secondary donations from a website visitor;
said software tracking the purpose of the donation, raffle or secondary;
said software tracking the location of the billing address for each donation;
said software creating a receipt for each donor.

23. The system of claim 22, wherein said receipt is compatible with IRS forms used to declare donations made to tax-exempt entities.

24. The system of claim 22, further comprising:
said software creating a report for each raffle winner, said report declaring the value of any prizes won by the raffle winner.

25. The system of claim 24, wherein said report for each raffle winner is compatible with IRS forms used to declare prizes won in games of chance.

26. The system of claim 22, further comprising:
said software creating a location specific report for each location where a donation is accepted from a website visitor.

27. The system of claim 22, wherein said location specific report includes an accounting for total funds raised, prizes distributed and value of the prizes.

28. A system for promoting internet based charitable events, comprising:
a website, said website hosting a plurality of internet based charitable raffle events, each internet based charitable raffle event having an event owner, said event owner is a charitable entity;
said website allowing a visitor to create a donor account, said donor account associated with at least an e-mail address;
said website allowing a donor account owner to select at least one interest area;
said website displaying at least one charitable event according to an interest area selected by the donor account owner;
said website processing a raffle donation from the donor account owner.

29. The system of claim 28, further comprising:
said website displays a plurality of charitable raffle events;
said website requesting that the donor account owner select a plurality of charitable raffle events to enter;
said website creating a shopping cart comprising the raffle donations for each event selected by the donor account owner;
said website processing one payment transaction for the shopping cart;
said website distributing raffle donations to each event owner for each for each event selected by the donor account owner.

30. The system of claim 29, further comprising:
said website creating a list of supporters for each charitable entity, said affinity group comprising donor account owners who have entered at least one event.

31. The system of claim 29, further comprising:
said website allowing a donor account holder to set preferences to automatically enter future events for charities of the donor account holder's choice.

32. The system of claim 31, further comprising:
said preferences include a maximum dollar amount that will result in automatic entry;
wherein donor account owners who have selected automatic entry are automatically entered if a raffle donation price is less than or equal to the maximum dollar amount; and
wherein said website requests authorization from the donor account holder if a raffle donation price is greater than the default maximum dollar amount.

33. The system of claim 31, further comprising:
a default maximum dollar amount is set for automatic entry;
wherein donor account owners who have selected automatic entry are automatically entered if a raffle donation price is less than or equal to the default maximum dollar amount;
wherein said website requests authorization from the donor account holder if a raffle donation price is greater than the default maximum dollar amount.
